(19) United States
(12) Patent Application Publication
(10) Pub. No.: US 2025/0344904 A1
(43) Pub. Date: Nov. 13, 2025

(54) SHOCK ABSORBING BUSHING

(71) Applicant: Zachary David Dinicola, Augusta, KS (US)

(72) Inventor: Zachary David Dinicola, Augusta, KS (US)

(21) Appl. No.: 19/201,498

(22) Filed: May 7, 2025

Related U.S. Application Data
(60) Provisional application No. 63/731,474, filed on May 7, 2024.

(51) Int. Cl. A47J 43/044; A47J 43/08; F16F 1/38

(52) U.S. Cl. CPC A47J 43/044; A47J 43/082; F16F 1/3814; A47J 2043/04472; A47J 2043/0449

(57) ABSTRACT

Methods and systems are herein disclosed, including a mixing apparatus, comprising a mixing base, an upright support column, a mixing head, and a bushing. The mixing base has a top face defining a mixing platform. The upright support column extends outwardly from the top face. The mixing head comprises a motor, a housing, and a drive shaft. The drive shaft extends outwardly from the outer housing surface and is operatively connected to the motor. The drive shaft has an implement securement portion configured to engage a mixing implement. The mixing head is pivotally attached to the upright support column such that the mixing head is movable between an operating position and a resting position. The bushing is configured to dampen an impact force exerted on the bushing when the mixing head is moved from the resting position to the operating position.

### FEDERALLY SPONSORED RESEARCH AND DEVELOPMENT

Not applicable.

### CROSS-REFERENCE TO RELATED APPLICATIONS

This application claims priority to the provisional patent application identified by U.S. Ser. No. 63/731,474, filed May 7, 2024, the entire content of which is hereby expressly incorporated herein by reference.

### FIELD OF THE INVENTION

The disclosure generally relates to methods and apparatuses that mix, blend, knead, process, and/or prepare food ingredients. More particularly, the disclosure relates to food preparation apparatuses with adjustable mixing heads that can be tilted away from a mixing platform to facilitate access to mixing implements attached to the adjustable mixing head and/or mixing bowls disposed on the mixing platform.

### BACKGROUND ART

Food mixing apparatuses with adjustable mixing heads, such as tilt-head mixers, are well-known conveniences for preparing food in both domestic and commercial settings. Typically, these apparatuses, sometimes referred to as stand mixers, are designed for use on tabletops, countertops, or other platforms, making them portable appliances or small appliances that may be used in the preparation of meals and other foods.

Many food mixing apparatuses include a motor housing, electronics to control the operation of the motor, and a variety of mixing implements. Examples of such mixing implements include mixing beaters, dough hooks, and wire whips, which can be attached to the adjustable mixing head to mix, blend, knead, process, and/or prepare food ingredients. Conventional forms of food mixing apparatuses often include a working bowl disposed on a mixing platform, with a motor-driven shaft projecting upwardly in the center of the bowl, driven by an encased motor with speed controls.

One popular example of such a food mixing apparatus is the KitchenAid® Mixer, which features an adjustable mixing head that can be tilted away from the mixing platform to facilitate access to mixing implements attached to the adjustable mixing head and/or mixing bowls disposed on the mixing platform.

However, both commercial and consumer models of these food mixing apparatuses are sometimes produced with design flaws that, in use, cause the mixer to prematurely wear out or cause undue maintenance issues with associated costs. One such design flaw is that a tilted-up head on a mixing apparatus can be dropped accidentally, causing undue wear and damage to the mixer unit. The shock to the unit can potentially damage internal components and affect the longevity of the food mixing apparatus.

The present disclosure addresses and corrects such design flaws with improvements that offer extended life and enhancements to food mixing apparatuses with adjustable mixing heads.

### SUMMARY OF THE INVENTION

An apparatus is disclosed. The problem of the tilted-up head of a food mixing apparatus being susceptible to being dropped, thereby causing undue wear and damage to the food mixing apparatus, is addressed through the inclusion of a shock-absorbing bushing that can be installed to mitigate the impact when the adjustable mixing head is returned to its operating position. Additional features of the present disclosure include quick and easy installation of the disclosed improvements, allowing users to retrofit existing food mixing apparatuses with minimal effort.

In a first aspect, the present disclosure includes a food mixing apparatus, comprising: a mixing base having a bottom face configured to rest on a flat surface and a top face opposite the bottom face, the top face defining a mixing platform; an upright support column integrally formed with or attached to the mixing base, the upright support column extending outwardly from the top face of the mixing base adjacent to the mixing platform; a mixing head comprising a motor, a housing having an inner housing surface enclosing the motor and an outer housing surface opposite the inner housing surface, and a drive shaft extending outwardly from the outer housing surface and being operatively connected to the motor such that the motor is operable to rotate the drive shaft about an axis, the drive shaft having an implement securement portion configured to engage a mixing implement, the mixing head pivotally attached to the upright support column such that the mixing head is movable between an operating position in which the implement securement portion is brought closer to the mixing platform and a resting position in which the implement securement portion is brought further away from the mixing platform; and a bushing disposed between the mixing head and the upright support column, the bushing configured to dampen an impact force exerted on the bushing when the mixing head is moved from the resting position to the operating position.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a perspective view of an exemplary embodiment of a food mixing apparatus constructed in accordance with the present disclosure, wherein a mixing head of the food mixing apparatus is in a resting position;

FIG. 2 is a perspective view of the mixing apparatus shown in FIG. 1, wherein the mixing head of the food mixing apparatus is in an operating position;

FIG. 3 is a partial block diagram of the mixing head shown in FIG. 1;

FIG. 4 is an enlarged front view of the food mixing apparatus shown in FIG. 1 as indicated by a rectangle in FIG. 1;

FIG. 5 is a perspective view of an exemplary embodiment of a bushing constructed in accordance with the present disclosure;

FIG. 6 is a top plan view of the bushing shown in FIG. 5;

FIG. 7 is a side plan view of the bushing shown in FIGS. 5 and 6;

FIG. 8 is a cross-sectional view of the bushing shown in FIG. 4, taken along the line 8-8 and in the direction of the arrows;

FIG. 9 is a perspective view of an exemplary embodiment of a mixing implement constructed in accordance with the present disclosure, wherein the mixing implement is implemented as a flexible-edge beater;

FIG. 10 is a perspective view of another exemplary embodiment of the mixing implement shown in FIG. 9, wherein the mixing implement is implemented as a flat beater;

FIG. 11 is a perspective view of another exemplary embodiment of the mixing implement shown in FIGS. 9 and 10, wherein the mixing implement is implemented as a wire whip;

FIG. 12 is a perspective view of another exemplary embodiment of the mixing implement shown in FIGS. 9-11, wherein the mixing implement is implemented as a dough hook; and

FIG. 13 is a perspective view of another exemplary embodiment of the mixing implement shown in FIGS. 9-12, wherein the mixing implement is implemented as a pastry beater.

### DETAILED DESCRIPTION

The following detailed description refers to the accompanying drawings. The same reference numbers in different drawings may identify the same or similar elements.

As used herein, the terms “comprises,” “comprising,” “includes,” “including,” “has,” “having”, or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

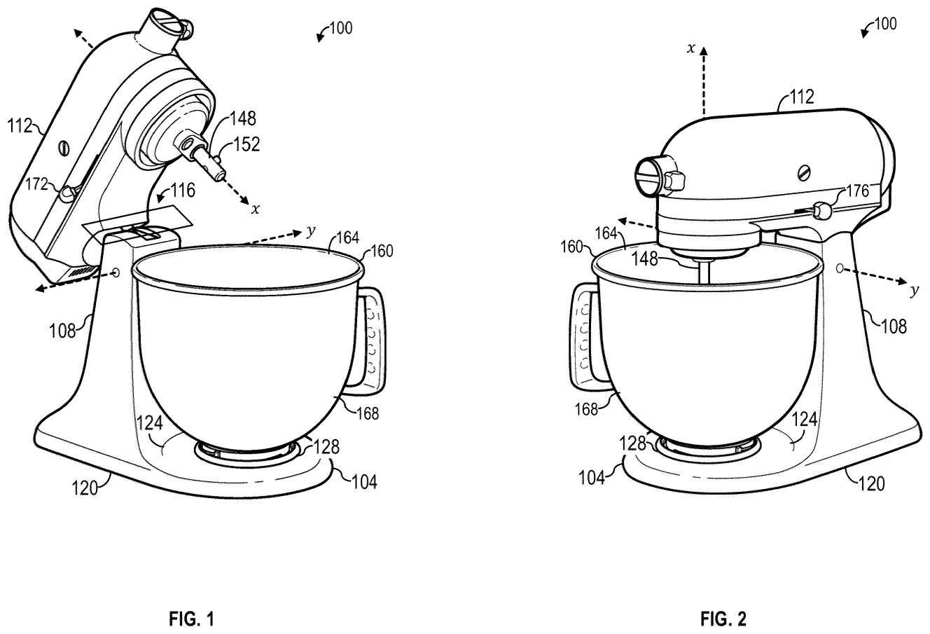

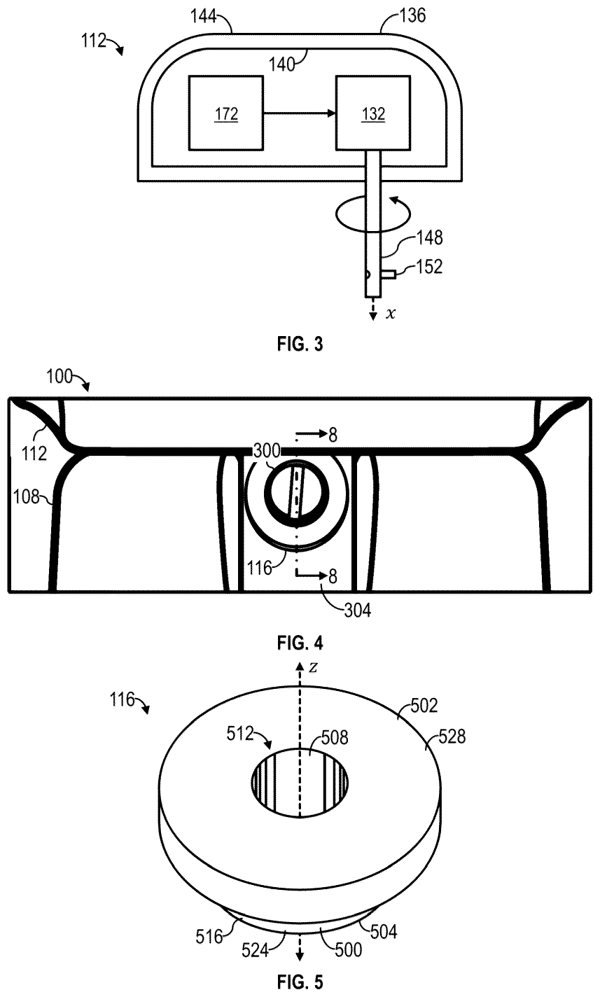

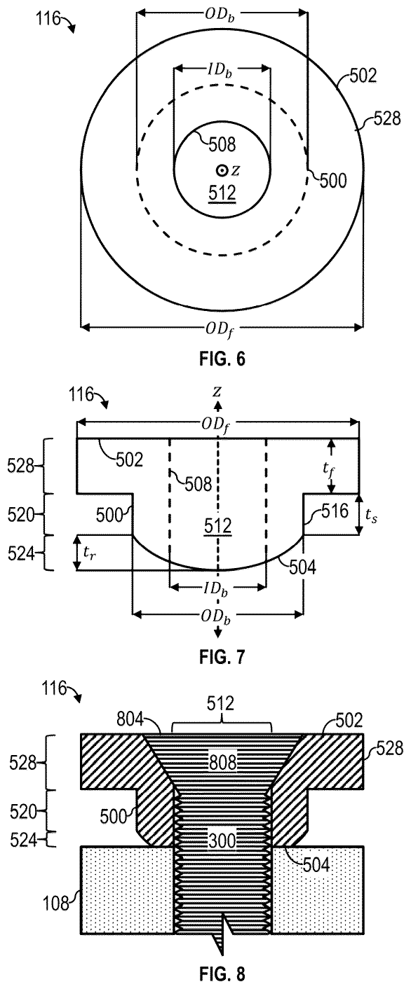

Referring now to the drawings, and in particular to FIGS. 1 and 2, shown therein is an exemplary embodiment of a food mixing apparatus 100 constructed in accordance with the present disclosure. The food mixing apparatus 100 may generally comprise a mixing base 104, an upright support column 108, a mixing head 112, and a bushing 116, which is shown in greater detail in FIGS. 3 and 5-7.

The mixing base 104 may have a bottom face 120 and a top face 124 opposite the bottom face 120. The bottom face 120 may be configured to rest on a flat surface, while the top face 124 may define a mixing platform 128.

The upright support column 108 may be integrally formed with or attached to the mixing base 104 and may extend outwardly (i.e., upwardly) from the top face 124 of the mixing base 104 adjacent to the mixing platform 128.

The mixing head 112 may comprise a motor 132 (shown in FIG. 3), a housing 136 having an inner housing surface 140 (shown in FIG. 3) enclosing the motor 132 and an outer housing surface 144 opposite the inner housing surface 140, and a drive shaft 148 extending outwardly from the outer housing surface 144 and being operatively connected to the motor 132 such that the motor 132 may be operable to rotate the drive shaft 148 about a rotational axis x. The drive shaft 148 may have an implement securement portion 152 configured to engage a mixing implement 156 (shown in FIGS. 9-13).

The mixing head 112 may be pivotally attached to the upright support column 108 such that the mixing head 112 may be movable (i.e., pivotable) about a pivot axis y between an operating position (shown in FIG. 2) in which the implement securement portion 152 is brought closer to the mixing platform 128 and a resting position (shown in FIG. 1) in which the implement securement portion 152 is brought further away from the mixing platform 128.

As described in more detail below, the bushing 116 may be disposed between the mixing head 112 and the upright support column 108 and may be configured to dampen an impact force exerted on the upright support column 108 when the mixing head 112 is moved from the resting position to the operating position.

In some embodiments, as shown in FIGS. 1 and 2, the food mixing apparatus 100 may further comprise a mixing bowl 160 removably secured to the mixing platform 128 and having a bowl inner surface 164 and a bowl outer surface 168 opposite the bowl inner surface 164. In some embodiments, when the mixing head 112 is in the operating position, the mixing implement 156 may contact the bowl inner surface 164. Conversely, in such embodiments, when the mixing head 112 is in the resting position, the mixing implement 156 may not contact the bowl inner surface 164.

In some embodiments, as shown in FIG. 1, the food mixing apparatus 100 may further comprise a control panel 172 operatively connected to the motor 132 (as shown in FIG. 3) and operable to control operation of the motor 132. In some embodiments, as shown in FIG. 2, the food mixing apparatus 100 may further comprise a locking mechanism 176 configured to secure the mixing head 112 in the operating position.

In some embodiments, one or more of the mixing base 104, the upright support column 108, and the housing 136 of the mixing head 112 may be at least partially formed from a rigid plastic, such as polypropylene (PP), polyethylene terephthalate (PET), high-density polyethylene (HDPE), low-density polyethylene (LDPE), polyvinyl chloride (PVC), polystyrene (PS), polycarbonate (PC), combinations thereof, and/or the like. However, in other embodiments, one or more of the mixing base 104, the upright support column 108, and the housing 136 of the mixing head 112 may be at least partially formed from a rigid metal, such as aluminum, copper, stainless steel, combinations thereof, and/or the like.

Referring now to FIG. 4, in some embodiments, the food mixing apparatus 100 may further comprise a height adjustment screw 300. The height adjustment screw 300 may be generally operable to adjust the height of the mixing head 112 relative to the mixing platform 128. Raising the mixing head 112 relative to the mixing platform 128 may provide more clearance between the mixing implement 156 and the bowl inner surface 164 of the mixing bowl 160 such that the mixing implement 156 does not contact the bowl inner surface 164. As explained in more detail below, in some embodiments, the mixing implement 156 may be provided with an enamel coating which could be stripped off if the mixing implement 156 scrapes against the bowl inner surface 164. Thus, raising the mixing head 112 relative to the mixing platform 128 may prevent the enamel coating of the mixing implement 156 to be stripped off.

The height adjustment screw 300 may be threadingly engaged with a portion 304 of the upright support column 108 such that rotation of the height adjustment screw 300 in a first direction (e.g., clockwise or counter-clockwise) increases a vertical distance between the mixing platform 128 and the mixing head 112 and rotation of the height adjustment screw 300 in a second direction (e.g., counter-clockwise or clockwise) decreases the vertical distance between the mixing platform 128 and the mixing head 112.

As shown in FIG. 4, in such embodiments, the bushing 116 may be disposed between the height adjustment screw 300 and the portion 304 of the upright support column 108. In such embodiments the height adjustment screw 300 may be further threadingly engaged with a bushing inner surface 308 (shown in FIGS. 5-8) of the bushing 116.

The height adjustment screw 300 is generally operable to adjust the height of the mixing head 112 relative to the mixing platform 128.

Referring now to FIGS. 5-8, in some embodiments, the bushing 116 may have a bushing body 500 having a cylindrical shape with a first bushing end 502, a second bushing end 504 opposite the first bushing end 502, a bushing longitudinal axis z extending between the first bushing end 502 and the second bushing end 504, a bushing inner surface 508 defining a central bushing aperture 512 extending between the first bushing end 502 and the second bushing end 504 along the bushing longitudinal axis z and having a bushing inner diameter ID_{b}, and a bushing outer surface 516 opposite the bushing inner surface 508 and having a bushing outer diameter OD_{b}. The bushing body 500 may have a straight portion 520 and a rounded portion 524, where the straight portion 520 has a straight thickness tₛ and the rounded portion 524 has a rounded thickness tᵣ. A bushing flange 528 may extend radially outward from the first bushing end 502 and may have a flange thickness t_{f} and a flange outer diameter OD_{f} greater than the bushing outer diameter OD_{b}.

In some embodiments, the bushing inner diameter ID_{b} is in a range between 0.1 inches and 0.3 inches (e.g., 0.21875 inches), the bushing outer diameter OD_{b} is in a range between 0.3 inches and 0.5 inches (e.g., 0.3875 inches), the flange outer diameter OD_{f} is in a range between 0.6 inches and 0.7 inches (e.g., 0.64 inches), the straight thickness tₛ is in a range between 0.05 inches and 0.2 inches (e.g., 0.09375 inches), the round thickness tᵣ is in a range between 0.2 inches and 0.3 inches (e.g., 0.26875 inches), and the flange thickness t_{f} is in a range between 0.1 inches and 0.2 inches (e.g., 0.125 inches).

As shown in FIG. 8, when the bushing 116 is installed with the second bushing end 504 contacting the upright support column 108 and the height adjustment screw 300 threadingly engaging the central bushing aperture 512, at least a portion of the bushing body 500 (e.g., the rounded portion 524 as shown in FIG. 8) may be compressed. While the bushing 116 is shown in FIG. 8 with only the rounded portion 524 being compressed, it should be understood that the compression may be distributed between the straight portion 520, the rounded portion 524, and the bushing flange 528.

As further shown in FIG. 8, the height adjustment screw 300 may have a screw body 800 having a cylindrical shape with a first screw end 804, a second screw end (not shown) opposite the first screw end 804, and a screw head 808 extending radially from the first screw end 804. When the height adjustment screw 300 is installed, the screw head 808 (i.e., the first screw end 804) may be flush (i.e., countersunk) with the first bushing end 502 of the bushing 116.

In some embodiments, the bushing 116 may be at least partially formed from a force-dampening material configured to dampen impact forces exerted on the bushing 116 in a direction parallel to the bushing longitudinal axis z. In such embodiments, the force-dampening material may be an elastic material, such as urethane rubber, silicone rubber, natural rubber, ethylene propylene diene monomer (EPDM), neoprene, thermoplastic elastomers (TPE), butyl rubber, combinations thereof, and/or the like. In other embodiments, however, the bushing 116 may be at least partially formed from a rigid metal, such as aluminum, copper, stainless steel, combinations thereof, and/or the like, wherein the metal has the force-dampening material applied to the rigid metal as a coating. Accordingly, the bushing 116 may have a force-dampening coating applied thereto.

In embodiments in which the bushing 116 is at least partially formed of an elastic material, the bushing 116 may be further configured to secure the height adjustment screw 300 in place, thereby preventing the height adjustment screw 300 from loosening or tightening due to vibration of the food mixing apparatus 100.

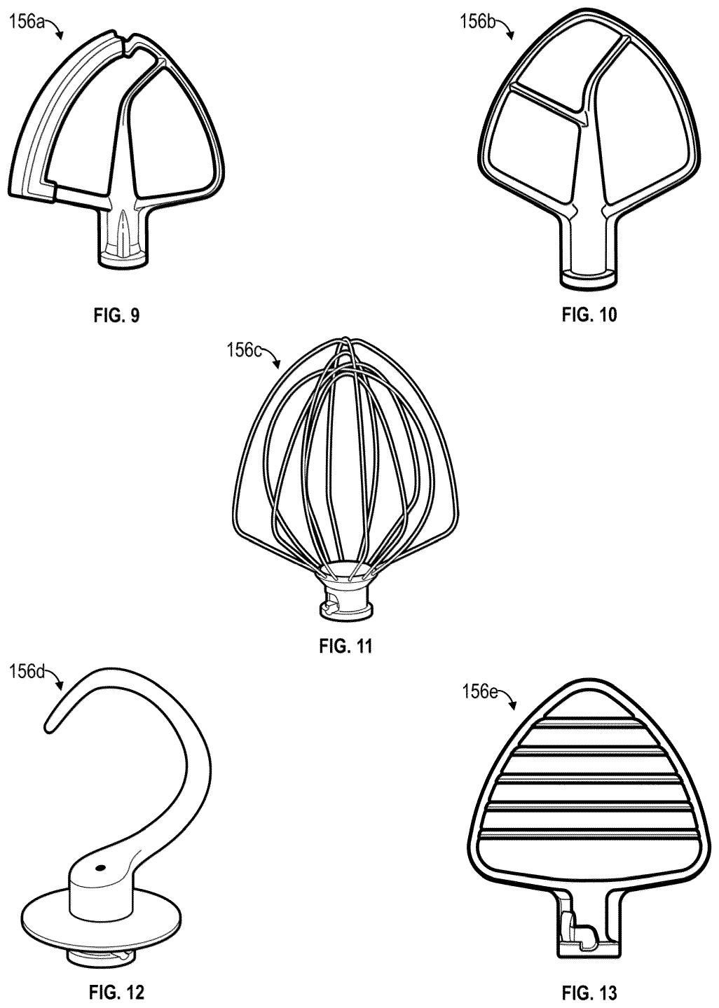

Referring now to FIGS. 9-13, in certain embodiments, the mixing implement 156 may be implemented as one of a flexible edge beater 156a (shown in FIG. 9), a flat beater 156b (shown in FIG. 10), a wire whip 156c (also referred to as a “whisk”) (shown in FIG. 11), a dough hook 156d (shown in FIG. 12) and a pastry beater 156e (shown in FIG. 13), for example.

In some embodiments, the mixing implement 156 may be at least partially formed from a thermoplastic elastomer material. In at least one such embodiment, the mixing implement 156 may be further provided with an enamel coating.

### Illustrative Clauses

Exemplary, non-limiting illustrative clauses are provided in the clauses below. However, the scope of the present inventive concept(s) is to be understood to not be limited in any manner by the clauses presented below.
Illustrative clause 1. A food mixing apparatus, comprising: a mixing base having a bottom face configured to rest on a flat surface and a top face opposite the bottom face, the top face defining a mixing platform; an upright support column integrally formed with or attached to the mixing base, the upright support column extending outwardly from the top face of the mixing base adjacent to the mixing platform; a mixing head comprising a motor, a housing having an inner housing surface enclosing the motor and an outer housing surface opposite the inner housing surface, and a drive shaft extending outwardly from the outer housing surface and being operatively connected to the motor such that the motor is operable to rotate the drive shaft about an axis, the drive shaft having an implement securement portion configured to engage a mixing implement, the mixing head pivotally attached to the upright support column such that the mixing head is movable between an operating position in which the implement securement portion is brought closer to the mixing platform and a resting position in which the implement securement portion is brought further away from the mixing platform; and a bushing disposed between the mixing head and the upright support column, the bushing configured to dampen an impact force exerted on the upright support column when the mixing head is moved from the resting position to the operating position.
Illustrative clause 2. The food mixing apparatus of illustrative clause 1, wherein the bushing comprises: a bushing body having a cylindrical shape with a first bushing end, a second bushing end opposite the first bushing end, a bushing longitudinal axis extending between the first bushing end and the second bushing end, a bushing inner surface defining a central bushing aperture extending between the first bushing end and the second bushing end along the bushing longitudinal axis, and a bushing outer surface opposite the bushing inner surface and having a bushing outer diameter; and a bushing flange extending radially outward from the first bushing end of the bushing body, the bushing flange having a flange outer diameter greater than the bushing outer diameter; wherein the bushing is at least partially formed from a force-dampening material configured to dampen the impact force exerted on the bushing in a direction parallel to the bushing longitudinal axis.
Illustrative clause 3. The food mixing apparatus of illustrative clause 2, wherein a distance between the first bushing end and the second bushing end is in a range between 0.2 and 0.4 inches.
Illustrative clause 4. The food mixing apparatus of illustrative clause 2, wherein the bushing outer diameter is in a range between 0.3 inches and 0.5 inches, and the flange outer diameter is in a range between 0.6 and 0.7 inches.
Illustrative clause 5. The food mixing apparatus of illustrative clause 2, wherein the force-dampening material is an elastic material.
Illustrative clause 6. The food mixing apparatus of illustrative clause 5, wherein the force-dampening material is urethane rubber.
Illustrative clause 7. The food mixing apparatus of illustrative clause 2, wherein the force-dampening material is a force-dampening coating, the bushing body and the bushing flange being formed from a rigid metal having the force-dampening coating disposed thereon.
Illustrative clause 8. The food mixing apparatus of illustrative clause 1, further comprising a mixing bowl removably secured to the mixing platform and having a bowl inner surface and a bowl outer surface opposite the bowl inner surface.
Illustrative clause 9. The food mixing apparatus of illustrative clause 8, further comprising the mixing implement removably secured to the implement securement portion of the drive shaft such that, when the mixing head is in the operating position, the mixing implement contacts the bowl inner surface, and when the mixing head is in the resting position, the mixing implement does not contact the bowl inner surface.
Illustrative clause 10. The food mixing apparatus of illustrative clause 9, wherein the mixing implement is one of a flexible-edge beater, a flat beater, a paddle, a wire whip, a dough hook, and a pastry beater.
Illustrative clause 11. The food mixing apparatus of illustrative clause 9, wherein the mixing implement is formed from a thermoplastic elastomer material.
Illustrative clause 12. The food mixing apparatus of illustrative clause 9, wherein the mixing implement has an enamel coating.
Illustrative clause 13. The food mixing apparatus of illustrative clause 1, further comprising a locking mechanism configured to secure the mixing head in the operating position.
Illustrative clause 14. The food mixing apparatus of illustrative clause 1, further comprising a height adjustment screw threadingly engaged with a portion of the upright support column such that rotation of the height adjustment screw in a first direction increases a vertical distance between the mixing platform and the mixing head and rotation of the height adjustment screw in a second direction opposite the first direction decreases the vertical distance between the mixing platform and the mixing head.
Illustrative clause 15. The food mixing apparatus of illustrative clause 14, wherein the bushing is disposed between the height adjustment screw and the portion of the upright support column, the height adjustment screw being further threadingly engaged with a bushing inner surface of the bushing.
Illustrative clause 16. The food mixing apparatus of illustrative clause 15, wherein the height adjustment screw has a screw body having a cylindrical shape with a first screw end and a second screw end opposite the first screw end, and a screw head extending radially from the first screw end, the bushing having a first bushing end and a second bushing end opposite the first bushing end, the second bushing end contacting the upright support column, the screw head being flush with the first bushing end.
Illustrative clause 17. The food mixing apparatus of illustrative clause 1, wherein one or more of the mixing base, the upright support column, and the housing are formed from a rigid plastic.
Illustrative clause 18. The food mixing apparatus of illustrative clause 17, wherein the rigid plastic is polypropylene.
Illustrative clause 19. The food mixing apparatus of illustrative clause 1, wherein one or more of the mixing base, the upright support column, and the housing are formed from a rigid metal.
Illustrative clause 20. The food mixing apparatus of illustrative clause 19, wherein the rigid metal is aluminum.

### Conclusion

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A food mixing apparatus, comprising:
a mixing base having a bottom face configured to rest on a flat surface and a top face opposite the bottom face, the top face defining a mixing platform;
an upright support column integrally formed with or attached to the mixing base, the upright support column extending outwardly from the top face of the mixing base adjacent to the mixing platform;
a mixing head comprising a motor, a housing having an inner housing surface enclosing the motor and an outer housing surface opposite the inner housing surface, and a drive shaft extending outwardly from the outer housing surface and being operatively connected to the motor such that the motor is operable to rotate the drive shaft about an axis, the drive shaft having an implement securement portion configured to engage a mixing implement, the mixing head pivotally attached to the upright support column such that the mixing head is movable between an operating position in which the implement securement portion is brought closer to the mixing platform and a resting position in which the implement securement portion is brought further away from the mixing platform; and
a bushing disposed between the mixing head and the upright support column, the bushing configured to dampen an impact force exerted on the upright support column when the mixing head is moved from the resting position to the operating position.

2. The food mixing apparatus of claim 1, wherein the bushing comprises:
a bushing body having a cylindrical shape with a first bushing end, a second bushing end opposite the first bushing end, a bushing longitudinal axis extending between the first bushing end and the second bushing end, a bushing inner surface defining a central bushing aperture extending between the first bushing end and the second bushing end along the bushing longitudinal axis, and a bushing outer surface opposite the bushing inner surface and having a bushing outer diameter; and
a bushing flange extending radially outward from the first bushing end of the bushing body, the bushing flange having a flange outer diameter greater than the bushing outer diameter;
wherein the bushing is at least partially formed from a force-dampening material configured to dampen the impact force exerted on the bushing in a direction parallel to the bushing longitudinal axis.

3. The food mixing apparatus of claim 2, wherein a distance between the first bushing end and the second bushing end is in a range between 0.2 and 0.4 inches.

4. The food mixing apparatus of claim 2, wherein the bushing outer diameter is in a range between 0.3 inches and 0.5 inches, and the flange outer diameter is in a range between 0.6 and 0.7 inches.

5. The food mixing apparatus of claim 2, wherein the force-dampening material is an elastic material.

6. The food mixing apparatus of claim 5, wherein the force-dampening material is urethane rubber.

7. The food mixing apparatus of claim 2, wherein the force-dampening material is a force-dampening coating, the bushing body and the bushing flange being formed from a rigid metal having the force-dampening coating disposed thereon.

8. The food mixing apparatus of claim 1, further comprising a mixing bowl removably secured to the mixing platform and having a bowl inner surface and a bowl outer surface opposite the bowl inner surface.

9. The food mixing apparatus of claim 8, further comprising the mixing implement removably secured to the implement securement portion of the drive shaft such that, when the mixing head is in the operating position, the mixing implement contacts the bowl inner surface, and when the mixing head is in the resting position, the mixing implement does not contact the bowl inner surface.

10. The food mixing apparatus of claim 9, wherein the mixing implement is one of a flexible-edge beater, a flat beater, a paddle, a wire whip, a dough hook, and a pastry beater.

11. The food mixing apparatus of claim 9, wherein the mixing implement is formed from a thermoplastic elastomer material.

12. The food mixing apparatus of claim 9, wherein the mixing implement has an enamel coating.

13. The food mixing apparatus of claim 1, further comprising a locking mechanism configured to secure the mixing head in the operating position.

14. The food mixing apparatus of claim 1, further comprising a height adjustment screw threadingly engaged with a portion of the upright support column such that rotation of the height adjustment screw in a first direction increases a vertical distance between the mixing platform and the mixing head and rotation of the height adjustment screw in a second direction opposite the first direction decreases the vertical distance between the mixing platform and the mixing head.

15. The food mixing apparatus of claim 14, wherein the bushing is disposed between the height adjustment screw and the portion of the upright support column, the height adjustment screw being further threadingly engaged with a bushing inner surface of the bushing.

16. The food mixing apparatus of claim 15, wherein the height adjustment screw has a screw body having a cylindrical shape with a first screw end and a second screw end opposite the first screw end, and a screw head extending radially from the first screw end, the bushing having a first bushing end and a second bushing end opposite the first bushing end, the second bushing end contacting the upright support column, the screw head being flush with the first bushing end.

17. The food mixing apparatus of claim 1, wherein one or more of the mixing base, the upright support column, and the housing are formed from a rigid plastic.

18. The food mixing apparatus of claim 17, wherein the rigid plastic is polypropylene.

19. The food mixing apparatus of claim 1, wherein one or more of the mixing base, the upright support column, and the housing are formed from a rigid metal.

20. The food mixing apparatus of claim 19, wherein the rigid metal is aluminum.
